(19) United States
(12) Patent Application Publication
(10) Pub. No.: US 2012/0003026 A1
(43) Pub. Date: Jan. 5, 2012

(54) Writing Instrument With Removable Cartridge of Writing Material

(75) Inventors: William Thomas Geddes, Cockeysville, MD (US); Jennifer Michelle Weaver, Baltimore, MD (US)

(73) Assignee: Raymond Geddes & Company, Inc., Baltimore, MD (US)

(21) Appl. No.: 12/827,681

(22) Filed: Jun. 30, 2010

(51) Int. Cl. B43K 21/00

(52) U.S. Cl. 401/85

(57) ABSTRACT

A writing instrument includes a hollow elongated body with a tip disposed proximate a bottom end portion of the body, a removable cartridge for containing elongated writing material, and an advancing mechanism for incrementally advancing the writing material into and outwardly beyond an opening in the tip. The cartridge can be inserted into and removed from an opening in the writing instrument body. The cartridge does not move with respect to the body when the writing material is advanced by the advancing mechanism. The cartridge includes a cartridge body with a writing material outlet hole, and can include a lid with a lid hole and a bumper portion. The lid can be configured to slide between a closed position, covering the outlet hole, and an open position, not covering the outlet hole. In the open position, writing material may exit through the outlet hole and advanced toward the tip by the advancing mechanism.

### BACKGROUND OF THE INVENTION

1. Field of the Invention

The present invention relates to writing instruments. More particularly, the present invention relates to refillable writing instruments, such as refillable mechanical pencils, which have a removable cartridge for containing one or more writing materials.

2. Background Art

People use many different types and styles of writing instruments today. Refillable writing instruments, such as refillable pens or mechanical pencils, are among the many writing instruments used. Mechanical pencils, for example, can provide greater ease of use than traditional wood-based pencils. A mechanical pencil does not require sharpening, it can accommodate a larger supply of writing material (including, for example, marking cores commonly referred to as mechanical pencil leads), it can often be reloaded with additional writing material, and its length remains substantially unchanged throughout its useful life. Additionally, a mechanical pencil may be more readily adaptable to include features such as a shirt clip, replaceable eraser, and finger grip.

Conventional mechanical pencils suffer from particular drawbacks. For example, in order to reload writing material in a conventional mechanical pencil, it is necessary for a user to handle the writing material. Because writing material used in mechanical pencils is typically a solid made up of, for example, graphite, pigmentation agents, and/or binding agents, it can naturally deposit a mark on the person or object it contacts. As a result, the writing material can often deposit an undesired mark on the person handling it, and on anything else it comes into contact with, such as clothing, furniture, or documents. Additionally, the writing material typically used with mechanical pencils tends to be small and brittle, which makes the writing material readily susceptible to being dropped or broken by the person handling it, and also makes the writing material susceptible to being lost once dropped. Increasing this susceptibility is the difficulty in loading the writing material into conventional mechanical pencils. For example, some mechanical pencils may require removing an end portion of the pencil to access a small opening in the pencil through which the writing material can be inserted. Some mechanical pencils may require the writing material to be inserted through a hole in the writing tip of the mechanical pencil not much larger than the diameter of the writing material itself. Such loading techniques are cumbersome and can easily lead to broken, dropped, and/or lost writing material.

Additionally, writing instruments can be used to convey a sense of the user's style or interests. A conventional writing instrument may incorporate a design or slogan that conveys an interest of the user. In order to convey multiple interests a user may find it necessary to carry and use multiple writing instruments, each incorporating a different design or slogan. The transport and use of these multiple writing instruments may become cumbersome and increase the chance that the user may lose or misplace one or more of the writing instruments.

Therefore, a writing instrument is needed that can be easily refilled with writing material without handling the writing material, that decreases the writing material's susceptibility to being lost, dropped or broken, and that can convey multiple interests of the user. The present invention addresses these and other needs, and provides further related advantages.

### BRIEF SUMMARY OF THE INVENTION

Exemplary embodiments of the present invention include a writing instrument including a hollow elongated body with a bottom end portion and a top end portion, a tip disposed proximate the bottom end portion, a removable cartridge for containing elongated writing material, and an advancing mechanism for incrementally advancing the writing material into and outwardly beyond an opening in the tip. The cartridge does not move with respect to the body when the writing material is advanced by the advancing mechanism.

Exemplary embodiments of the present invention also include a writing instrument including an exposed hollow elongated body, a tip positioned near a bottom end portion of the body, a removable cartridge for containing an elongated writing material, and a side knock-type advancing mechanism for incrementally advancing the writing material into and outwardly beyond an opening in the tip.

Exemplary embodiments of the present invention also include a writing instrument including a removable cartridge for containing an elongated writing material, where the removable cartridge is configured to be axially slidably inserted into and removed from an opening in a top end portion of the writing instrument body. The cartridge includes a cartridge body including a first end and a second end spaced apart from the first end, the first end including a writing material outlet hole. The cartridge further includes a lid including a lid hole and a bumper portion, the lid being disposed on a first end of the cartridge body and being configured to slide between a closed position and an open position. In the closed position the lid substantially covers the outlet hole, and the bumper portion of the lid extends radially beyond a periphery of the first end of the cartridge body. In the open position the lid hole is substantially coaxially aligned with the outlet hole, and the bumper portion contacts an interior surface of the writing instrument body when the cartridge is inserted in the writing instrument body so as to cause the lid to slide from the closed position to the open position.

### BRIEF DESCRIPTION OF THE DRAWINGS/FIGURES

The accompanying drawings, which are incorporated herein and form a part of the specification, illustrate the present invention by way of example and not by way of limitation. The drawings, together with the description, serve to explain the principles of the invention and to enable a person skilled in the pertinent art to make and use the invention.

FIG. 1 is a side view of a writing instrument in accordance with an exemplary embodiment of the present invention.

FIG. 2 is an exploded view of the writing instrument of FIG. 1.

FIG. 3 is a further exploded view of the writing instrument of FIG. 1.

FIG. 4 is a top perspective view of a cartridge of the writing instrument of FIG. 1, in accordance with an exemplary embodiment of the present invention.

FIG. 5 is a bottom perspective view of the cartridge of FIG. 4 showing a writing material outlet hole in a closed position, in accordance with an exemplary embodiment of the present invention.

FIG. 6 is a bottom perspective view of the cartridge of FIG. 4, showing the writing material outlet hole in an open position, in accordance with an exemplary embodiment of the present invention.

FIG. 7 is an exploded view of the cartridge of FIGS. 5 and 6.

### DETAILED DESCRIPTION OF THE INVENTION

Exemplary embodiments of the present invention will be described with reference to the accompanying drawings, in which like reference numerals refer to identical or functionally similar elements. While specific configurations and arrangements are discussed, it should be understood that the exemplary embodiments are described for illustrative purposes only. A person skilled in the pertinent art will recognize that other configurations and arrangements can be realized without departing from the spirit and scope of the present invention. It will be apparent to a person skilled in the pertinent art that this invention can also be used in a variety of ways other than those described in the exemplary embodiments.

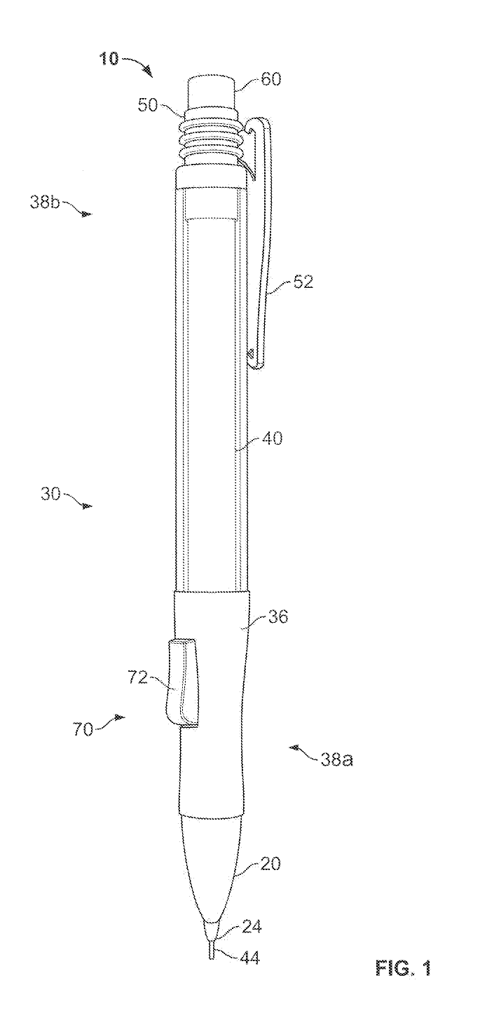

FIGS. 1-3 illustrate a writing instrument 10 in accordance with an exemplary embodiment of the present invention. Writing instrument 10 includes a head cap 20, a body 30, a cartridge 40, an end cap 50, and an advancing mechanism 70. Writing instrument 10 also optionally includes an eraser 60.

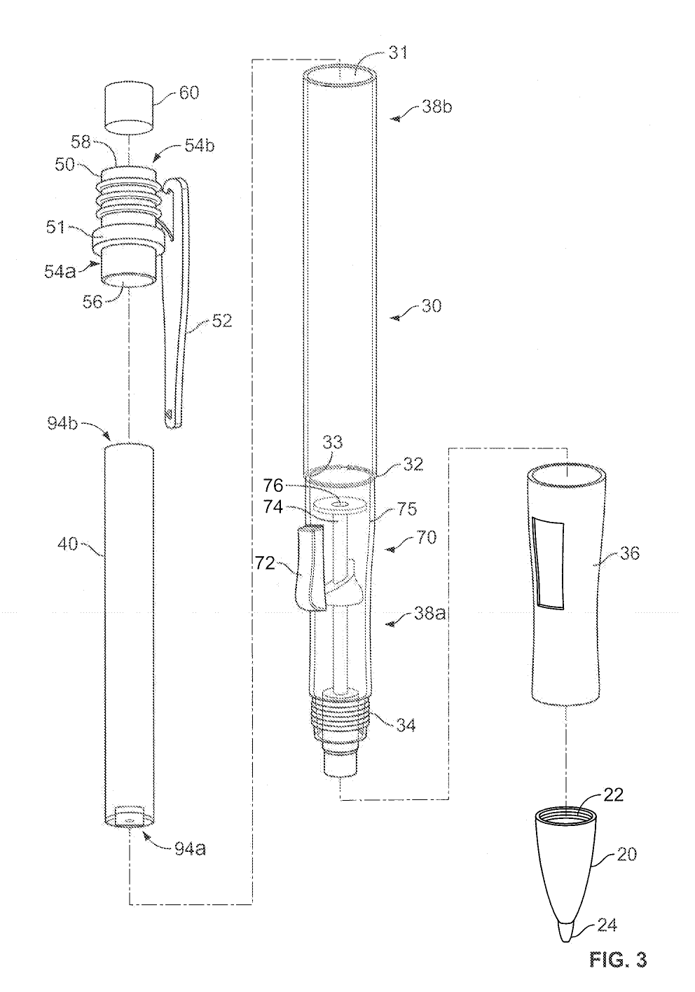

Body 30 is a hollow elongated body having a bottom end portion 38a and a top end portion 38b. Head cap 20 is joined to bottom end portion 38a of body 30. End cap 50 is joined to top end portion 38b of body 30. Cartridge 40 is joined to a bottom end 54a of end cap 50 and extends within body 30, and eraser 60 is joined to a top end 54b of end cap 50 and extends away from body 30. End cap 50 optionally includes a clip 52 that longitudinally extends adjacent to an exterior side of top end portion 38b of body 30. Clip 52 can be used to attach writing instrument 10 to various objects, such as, for example, a shirt pocket, folder, or notebook. As shown in FIG. 3, advancing mechanism 70 is positioned within an advancing mechanism housing 75 that forms a part of bottom end portion 38a of body 30.

In the embodiment shown, body 30 has a circular cross-sectional shape. The diameter of body 30 is substantially constant throughout top end portion 38b of body 30, and decreases at a transition 32 such that the diameter of body 30 at transition 32 is less than the diameter of top end portion 38b of body 30 above transition 32, such that transition 32 forms a projection 33 on the interior surface of body 30. In some embodiments, bottom end portion 38a of body 30 below transition 32 has substantially the same diameter as transition 32, and in some embodiments bottom end portion 38a may taper in diameter from transition 32 to a threaded portion 34 that joins head cap 20 to body 30. In some embodiments (not shown) body 30 may have different cross-sectional shapes, including, for example, triangular, hexagonal, ovate, and rectangular. Such embodiments include transition 32. Body 30 may be made of a rigid or flexible material, such as, for example, plastic, metal, rubber, or wood. In some embodiments, body 30 is made of plastic that is translucent, and in some embodiments the translucent plastic is transparent. In the embodiment of FIGS. 1-3, body 30 is made of transparent plastic. In other embodiments, body 30 is made of an opaque material.

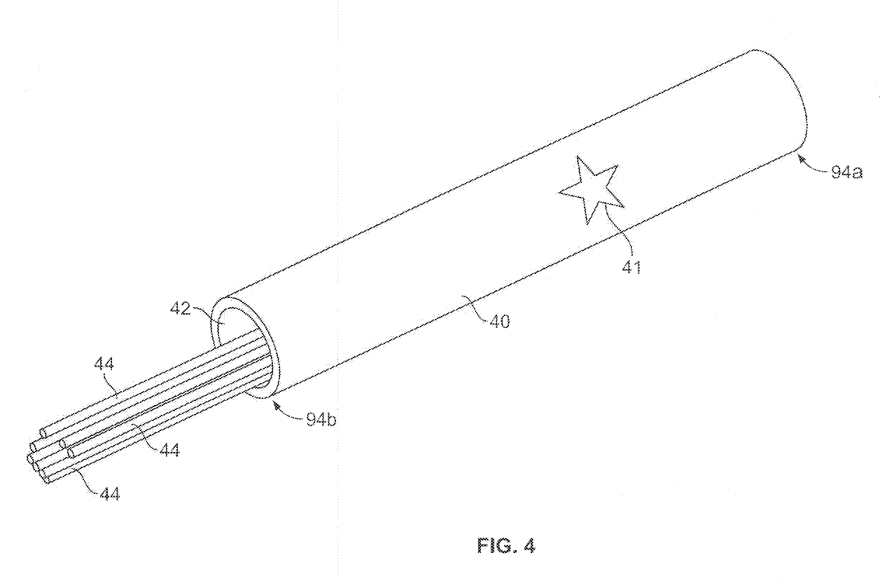

Head cap 20 is disposed between tip 24 and bottom end portion 38a of body 30 that houses advancing mechanism 70, and tapers from body 30 to tip 24. Tip 24 includes an opening having substantially the same diameter as an outer diameter of writing material 44 (see FIG. 4) that can be dispensed from tip 24. Head cap 20 can be joined to body 30 by any means as would be appreciated by one of skill in the art. In the embodiment shown, head cap 20 is joined to body 30 by a screw fit. As shown in FIG. 3, bottom end portion 38a of body 30 includes a threaded portion 34 that engages a corresponding interior threaded portion 22 of head cap 20. In some embodiments, head cap 20 can be joined to body 30 through other means, such as by press fit, interference fit, adhesive, riveting, fusing, and snap fit. Head cap 20 can be made of a material that is the same as or different from the material that forms body 30. For example, in some embodiments, body 30 is made of plastic and head cap 20 is made of metal. In some embodiments, head cap 20 can be integrally formed with body 30 such that body 30 and head cap 20 together form a monolithic structure. In some embodiments, head cap 20 can have an opening through which tip 24 extends. Tip 24 can be made of a material that is the same as or different from the material that forms head cap 20. In some embodiments, tip 24 can be integrally formed with head cap 20 as a monolithic structure.

Body 30 includes a grip 36, which can be integrally formed with body 30 or positioned over a portion, such as bottom end portion 38a, of body 30 in order to increase a user's comfort while using writing instrument 10. FIG. 3 shows grip 36 removed from bottom end portion 38a of body 30. Grip 36 may be made of a rigid or flexible material that may be the same as or different from the material that forms body 30. For example, in some embodiments, grip 36 is made of a material that is softer than the material that forms body 30. In some embodiments, grip 36 is soft plastic, rubber, foam, or a flexible plastic envelope containing gel or beads.

Advancing mechanism 70 is positioned within advancing mechanism housing 75 formed by body 30. Advancing mechanism 70 may be any suitable mechanism for advancing writing material such as would be known to one of skill in the art. In some embodiments, advancing mechanism 70 may be a side knock advancing mechanism as known in the art. For example, advancing mechanism 70 may be a side knock advancing mechanism for a mechanical pencil as described in U.S. Pat. No. 5,882,132 to Kageyama et al., the entire disclosure of which is incorporated herein in its entirety by reference thereto. As shown in the exemplary embodiment of FIG. 3, advancing mechanism 70 includes a side knock button 72 and an elongated plunger portion 74. Plunger portion 74 is positioned coaxially within bottom end portion 38a of body 30. Side knock button 72 is moveably positioned within a side opening of body 30 and has an inner portion that interfaces with plunger portion 74 and an outer portion that extends outside body 30 for actuation by a user. Plunger portion 74 includes an advancing hole 76 bored coaxially through the length of plunger portion 74. As known in the art, writing material 44 is received in advancing hole 76, and advanced through advancing hole 76 toward tip 24 by a user's actuation of side knock button 72.

Cartridge 40 is an elongated hollow body for containing one or more elongated writing materials 44 (see FIG. 4) that are individually dispensed from writing instrument 10 via advancing mechanism 70 and tip 24. In the embodiment shown, cartridge 40 has a cylindrical shape, and a circular cross-section. In some embodiments cartridge 40 may have different cross-sectional shapes, including, for example, triangular, hexagonal, ovate, and rectangular shapes. Cartridge 40 may be sized appropriately to accommodate a desired number of writing materials 44. In some embodiments, for example, cartridge 40 is sized to accommodate 10-30 writing materials 44, 5-20 writing materials 44 in other embodiments, and 5-10 writing materials 44 in other embodiments.

Cartridge 40 removably engages within a recess 56 in bottom end 54a of end cap 50 by an interference fit, and eraser 60 may be disposed within a recess 58 in top end 54b of end cap 50. Bottom end 54a of end cap 50 can be disposed in an opening 31 at the end of top end portion 38b of body 30 and releasably seal opening 31 by an interference fit. In some embodiments, bottom end 54a of end cap 50 can include a bottom rim 51 that can be positioned with an interference fit over an exterior surface of the top end portion 38b of body 30. Thus, when cartridge 40 is inserted in top end portion 38b of body 30 via opening 31, cartridge 40 is removably secured within top end portion 38b of body 30 by the interference fit of bottom rim 51 with top end portion 38b and/or with the interference fit of bottom end 54a in opening 31 of body 30.

Cartridge 40 can be permanently or releasably joined to end cap 50 by means other than an interference fit, as would be appreciated by one of skill in the art, including, for example, by threads, adhesive, riveting, fusing, press fit, and snap fit. Alternatively, cartridge 40 may be integrally formed with end cap 50 so as to constitute a monolithic structure. End cap 50 can also be releasably joined to body 30 by means other than an interference fit, as would be appreciated by one of skill in the art, including, for example by press fit, snap fit, releasable riveting, and threads, for example.

Cartridge 40 can be removably disposed within top end portion 38b of body 30, thereby allowing cartridge 40 to be replaced with another cartridge 40. For example, after writing material 44 in cartridge 40 is dispensed and cartridge 40 is empty first cartridge 40 can be removed and replaced with a second cartridge 40 containing additional writing material 44. Alternatively, cartridge 40 may be removed and refilled with additional writing material 44 and then reloaded into top end portion 38b of body 30. Thus, the user can load writing instrument 10 with additional writing material 44 by inserting cartridge 40 without having to directly handle the writing material 44 itself. As such, writing material 44 will not deposit an undesired mark on the user or surface during loading, and will not be broken or lost during loading.

A user may desire to replace the first cartridge 40 when all writing material 44 in the first cartridge 40 has been depleted, or to change the type of marking material that forms writing material 44, or for any other reason. In some embodiments, cartridge 40 may incorporate a slogan or graphic, or other indicia 41 (see FIG. 4). Indicia 41 may, for example, convey a sense of style, school spirit, or team spirit, may distinguish the cartridge 40 or writing instrument 10 from other cartridges or writing instruments, and/or may indicate the contents of cartridge 40. Indicia 41 may completely or partially cover the entire exterior surface of cartridge 40. In the embodiment shown, indicia 41 is a star design. Thus, the user may desire to replace cartridge 40 with another cartridge 40 to convey a different sense of style or spirit, to better distinguish writing instrument 10 from another writing instrument, and/or to change the writing material 44 used in writing instrument 10.

In some embodiments, the first cartridge 40 may be replaced by (i) disengaging end cap 50 to expose opening 31 at top end portion 38b of body 30 and pulling end cap 50 to remove the first cartridge 40 from body 30 through opening 31, (ii) removing the first cartridge 40 from end cap 50, (iii) joining the second cartridge 40 to end cap 50, and (iv) the inserting the second cartridge 40 into body 30 via opening 31 and securing end cap 50 to body 30 to seal close opening 31. In other embodiments, the second cartridge 40 includes its own second end cap 50, whereby steps (ii) and (iii) above can be omitted. In such a case, the first cartridge 40 may be replaced by removing the first cartridge 40 and first end cap 50 from body 30, and joining the second cartridge 40 with second end cap 50 to body 30. In some embodiments, cartridge 40 and end cap 50 may be irremovably joined together, such as by an adhesive or when the cartridge 40 and end cap 50 constitute a monolithic structure. In such embodiments, cartridge 40 and end cap 50 may both be removed and/or replaced with respect to body 30 as a single unit. Thus, the first cartridge 40 may be replaced by removing the first cartridge 40 and its end cap 50 from body 30, and joining the second cartridge 40 with its end cap 50 to body 30.

Eraser 60 can also be removable from recess 58 in top end 54b of end cap 50, thereby allowing eraser 60 to be replaced. For example, after eraser 60 is substantially depleted from use, eraser 60 may be removed from end cap 50 and replaced with another new or substantially unused eraser 60. Eraser 60 can be made of a suitable erasing material such as is commonly known in the art.

Writing material 44 can be any marking material suitable for dispensing from a writing instrument such as is known in the art, including, for example, cores of pigments and other fillers (e.g., clay) combined with graphite (typically referred to as “lead”), elemental lead, carbon, wax (e.g., as used in colored pencils, col-erase pencils, or crayons), chalk, oiled chalk (e.g., as used in oil pastels), grease (e.g., as used in grease pencils), charcoal, and any combination thereof. In some embodiments, writing instrument 10 is a mechanical pencil, and writing material 44 is a graphite writing material 44. In some embodiments, writing instrument 10 is a mechanical pencil that dispenses writing material 44 of pigmented wax typically used in colored pencils. In some embodiments, writing material 44 can be any one of the ISO standard sizes for lead used in mechanical pencils, including, for example, 2.00 mm, 1.40 mm, 1.00 mm, 0.70 mm, 0.50 mm, 0.35 mm, 0.25 mm, 0.18 mm, and 0.13 mm. In some embodiments, writing material 44 has a 0.9 mm lead size. In some embodiments, cartridge 40 may contain a plurality of writing materials 44 of more than one color and/or may contain a plurality of writing materials of more than one type of marking material. For example, cartridge 40 may contain one or more graphite cores and one or more colored wax cores (e.g., as used with colored pencils).

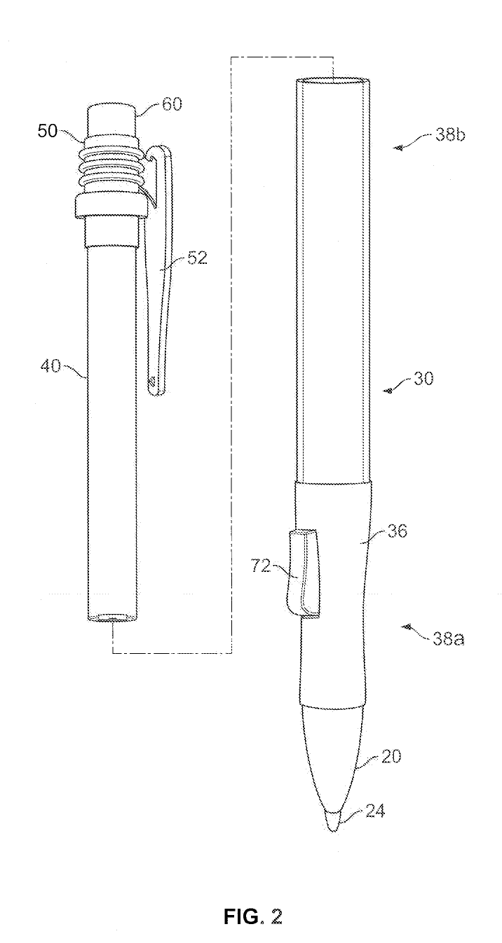

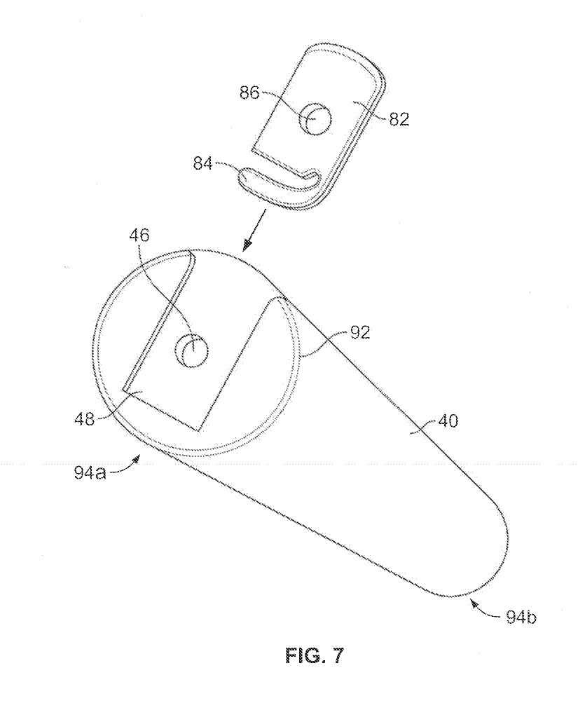

Further details of cartridge 40 according to an exemplary embodiment of the present invention will now be described with reference to FIGS. 4-7. The elongated hollow body of cartridge 40 has a first end 94a and a second end 94b, and an interior space 42 suitable for containing writing material 44. In the embodiment shown, second end 94b of cartridge 40 is open, thereby allowing easy insertion of writing material 44 into interior space 42 of cartridge 40 via second end 94b. Second end 94b of cartridge 40 is closed when joined to bottom end 54a of end cap 50 (see FIG. 2). First end 94a of cartridge 40 is closed except for a small outlet hole 46 that can be sized so as to be able to accommodate only one writing material 44 there through. Thus, cartridge 40 can be refilled and reused. For example, cartridge 40 may be refilled with additional one or more writing materials 44 by removing end cap 50 to access interior space 42 via the opening in second end 94b of cartridge 40. After refilling cartridge 40, end cap 50 can be disposed on second end 94b, and cartridge 40 can be inserted back into body 30 of writing instrument 10. In some embodiments, a seal (not shown) may be disposed over the opening in second end 94b, and in some embodiments, the seal may be removable, such as removable sealing foil. Alternatively, cartridge 40 can be permanently closed at second end 94b.

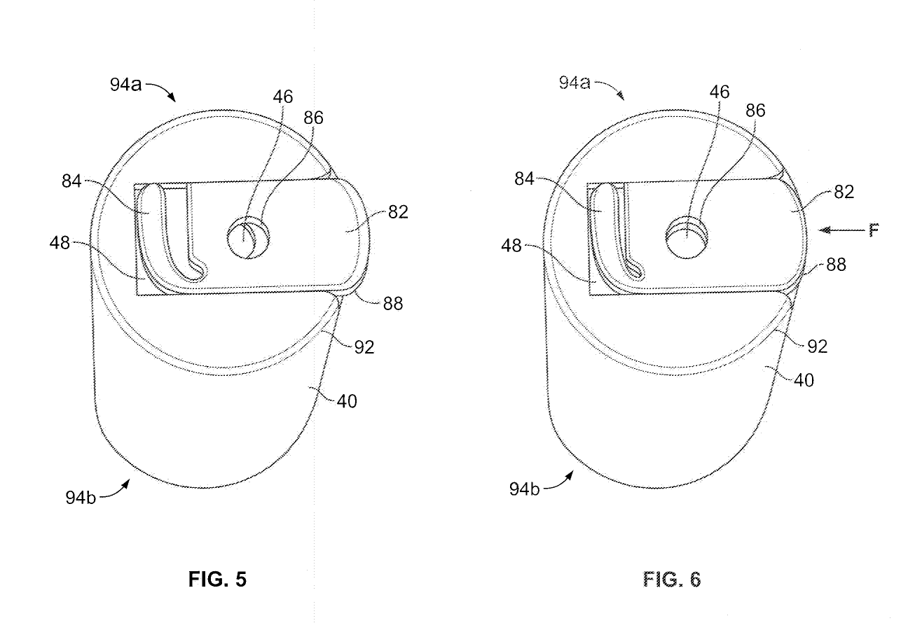

As shown in FIGS. 5-6, first end 94a of cartridge 40 includes outlet hole 46, a periphery 92, and a groove 48 for receiving a lid 82. Outlet hole 46 is positioned within groove 48. Lid 82 can include a spring member 84, a lid hole 86, and a bumper portion 88. Lid hole 86 can be sized similarly to outlet hole 46 of cartridge 40 so as to be able to accommodate only one writing material 44 there through. Lid 82 is slidably received within groove 48, and can slide from a closed position, illustrated in FIG. 5, to an open position, illustrated in FIG. 6, and vice versa. In the open position of FIG. 5, outlet hole 46 of cartridge 40 is substantially coaxially aligned with lid hole 86 such that one writing material 44 may exit cartridge 40 through aligned outlet hole 46 and lid hole 86. In the closed position of FIG. 6, outlet hole 46 of cartridge 40 is not substantially coaxially aligned with lid hole 86, and writing material 44 cannot exit cartridge 40 because it is blocked by a sufficient portion of lid 82 covering outlet hole 46.

Spring member 84 of lid 82 contacts a side wall of groove 48. Spring member 84 may be any suitable spring or spring mechanism as would be appreciated by one of skill in the art. In some embodiments spring member 84 is a cantilever spring as shown. In alternative embodiments, spring member 84 can be, for example, a coil spring, a helical spring, or a torsion spring. In a relaxed state, corresponding to the closed position illustrated in FIG. 5, spring member 84 maintains the position of lid 82 in groove 48 such that lid hole 86 is not coaxially aligned with outlet hole 46 of cartridge 40. In such a state, bumper portion 88 of lid 82 extends beyond periphery 92 of first end 94a of'cartridge 40. In the closed position, writing material 44 may be contained within cartridge 40 by lid 82 because outlet hole 46 of cartridge 40 and lid hole 86 of lid 82 are not substantially coaxially aligned to permit exit of writing material 44 there through.

In a compressed state of spring member 84, corresponding to the open position illustrated in FIG. 6, bumper portion 88 of lid 82 is subject to a force F such that spring member 84 is compressed against the side wall of groove 48, and lid 82 slides within groove 48. Lid 82 slides such that bumper portion 88 of lid 82 does not extend beyond periphery 92 of cartridge 40 and outlet hole 46 becomes exposed when lid hole 86 of lid 82 is substantially coaxially aligned with outlet hole 46 of cartridge 40. In the open position, any writing material 44 disposed within cartridge 40 can exit cartridge 40 through the aligned outlet hole 46 and lid hole 86.

In operation, cartridge 40 can be axially slideably removed from body 30 by disengaging end cap 50 from its interference fit with opening 31 at top end portion 38b of body 30 and pulling end cap 50 with cartridge 40 attached thereto through opening 31. When cartridge 40 is outside body 30, spring member 84 can be in the relaxed state because external force is not substantially applied to bumper portion 88 of lid 82. Consequently, when cartridge 40 is outside body 30, cartridge 40 is in the closed position corresponding to FIG. 5. Cartridge 40 can then be reloaded into body 30, or alternatively a second cartridge 40 in the closed position can be loaded into body, by axially slidably inserting cartridge 40 into body 30 via opening 31 at top end portion 38b of body 30. As shown in FIG. 3, first end 94a of cartridge 40 is inserted into body 30 first. Accordingly, cartridge 40 can be inserted while second end 94b still has end cap 50 attached thereto, as shown in FIG. 2. When cartridge 40 is being loaded into body 30, cartridge 40 remains in the closed position with lid 82 covering outlet hole 46 until first end 94a of cartridge 40 reaches transition 32, which can occur when cartridge 40 extends far enough inside body 30 so that cap 50 engages with top end portion 38b of body 30 and can seal close opening 31. When first end 94a of cartridge 40 first reaches transition 32, force F is exerted on bumper portion 88 of lid 82 by bumper portion 88 engaging with projection 33 on the interior surface of body 30. Force F compresses spring member 84 so as to cause lid 82 to slide within groove 48 to substantially align lid hole 86 with outlet hole 46. Consequently, when cartridge 40 is inside body 30 such that bumper portion 88 engages with projection 33 on the interior surface of body 30, cartridge 40 is in the open position corresponding to FIG. 6. In some embodiments, rather than decreasing in diameter at transition 32 to form projection 33, body 30 may incorporate a tab or other element that serves as projection 33 to apply force F to lid 82 when lid 82 is inserted into body 30. In some embodiments, hollow body 30 may retain its outer diameter while only its inner diameter may change at transition 32 to form projection 33.

When cartridge 40 is inside body 30 and in the open position, writing material 44 can exit cartridge 40 through aligned outlet hole 46 and lid hole 86. When writing instrument 10 is positioned such that bottom end portion 38a is pointing substantially downward, exit of writing material 44 from cartridge 40 may be facilitated by gravity. In some embodiments, in order to further facilitate exit of writing material 44 from cartridge 40, cartridge 40 may incorporate an interior guide such as a funnel (not shown) that directs an end of writing material 44 toward outlet hole 46. The end portion of writing material 44 discharged from cartridge 40 can engage with advancing mechanism 70. In some embodiments, advancing mechanism 70 is a side knock mechanism as shown, and the end portion of writing material 44 discharged from cartridge 40 may enter advancing hole 76 of advancing mechanism 70. By a user's actuation of side knock button 72, advancing mechanism 70 can incrementally advance writing material 44 into and outwardly beyond the opening in tip 24 of writing instrument 10. Cartridge 40 can remain stationary with respect to body 30 while writing material 44 discharged from cartridge 40 is advanced by actuation of advancing mechanism 70. Thus, while components (e.g., plunger portion 74) of advancing mechanism 70 may move with respect to body 30 when writing material 44 is advanced by advancing mechanism 70, cartridge 40 does not move with respect to body 30 when writing material 44 is advanced.

In order to write or draw using writing instrument 10, cartridge 40 containing writing material 44 is loaded into body 30, and writing material 44 exits cartridge 40 via outlet hole 46 and enters advancing hole 76 of advancing mechanism A user can then advance a desired amount of writing material 44 through advancing hole 76 and through tip 24. As writing material 44 is advanced beyond tip 24 of head cap 20 and used, writing material 44 becomes depleted, and more of writing material 44 may be advanced via actuation of advancing mechanism 70 in order to continue use of writing instrument 10 for writing or drawing. Once the first writing material 44 is completely discharged from cartridge 40 and becomes substantially depleted, an end portion of a second writing material 44 may exit cartridge 40 through aligned outlet hole 46 and lid hole 86. Second writing material 44 may enter advancing hole 76 of advancing mechanism 70 following the first writing material 44. In this way, a user can easily begin dispensing the second writing material 44 from tip 24 after the first writing material 44 is entirely depleted.

While various exemplary embodiments of the present invention have been described above, they have been presented by way of example only, and not limitation. For example, in some embodiments (not shown), lid 82 of cartridge 40 may be replaced with a hinged lid that selectively covers and uncovers outlet hole 46 in the closed position and open position, respectively. Such a hinged lid may be hinged on periphery 92 of first end 94a of cartridge 40 so as to pivot from a closed, horizontal position in which the hinged lid covers outlet hole 46 to an open, vertical position in which the hinged lid does not cover outlet hole 46 and outlet hole 46 is exposed. Such a hinged lid may include bumper portion 88 that extends radially beyond periphery 92 of first end 94a of cartridge 40 when hinged lid is in its close, horizontal position. Bumper portion 88 comes into contact with a projection, such as projection 33 formed by transition 32, on the interior surface of body 30, when cartridge 40 is inserted into body 30, whereby bumper portion 88 pivots the hinged lid on its hinge to the open, vertical position so as to uncover outlet hole 46. Also, for example, body 30 may include one or more ribs extending longitudinally along its interior surface, and cartridge 40 may include one or more channels extending longitudinally along its exterior surface, such that the ribs and channels may ensure that cartridge does not rotate within body 30. Moreover, projection 33 on the interior surface of body 30 may not extend around the entire inner circumference of body 30, whereby the ribs and channels can ensure that cartridge 40 is aligned in body 30 so that bumper portion 88 of lid 82, or the lever portion of the alternative hinged lid described above, comes into contact with projection 33 when cartridge 40 is inserted.

Further, for example, end cap 50 may not be removable from body 30. In such embodiments, cartridge 40 may be inserted and replaced within body 30 through an opening in end cap 50 which can be closed by eraser 60, whereby end cap 50 does not need to be removed from body 30 in order to insert cartridge 40 therein. In some embodiments, writing instrument 10 does not have an end cap. Rather, cartridge 40 can be inserted within body 30 via opening 31, and eraser 60 can be disposed directly on opening 31 so as to secure cartridge 40 within the end of top end portion 38b of body 30. In some embodiments, clip 52 can be fixed to an exterior surface of the cartridge rather than end cap 50, and clip 52 can longitudinally extend adjacent to an exterior side of top end portion 38b of body 30 when cartridge 40 is inserted in the body.

It therefore will be apparent to persons skilled in the relevant art that various changes in form and detail can be made therein without departing from the spirit and scope of the present invention. It is to be understood that the phraseology or terminology herein is used for description and not for limitation. Thus, it is intended that the present invention cover the modifications and variations of this invention provided they come within the scope of the appended claims, and their equivalents.

What is claimed is:

1. A writing instrument, comprising:
a hollow elongated body comprising a bottom end portion and a top end portion; a tip disposed proximate to the bottom end portion of the body and having an opening therein;
a removable cartridge disposed within the top end portion of the body and containing a plurality of elongated writing materials; and
an advancing mechanism disposed within the body for incrementally advancing a writing material into and outwardly beyond the opening in the tip, wherein the cartridge does not move with respect to the body when the writing material is advanced by the advancing mechanism.

2. The writing instrument of claim 1, wherein the advancing mechanism is a side knock advancing mechanism.

3. The writing instrument of claim 1, wherein the removable cartridge comprises:
a first end and a second end spaced apart from the first end, the first end having a writing material outlet hole; and
a lid disposed on the first end of the cartridge and moveable between a closed position in which the lid substantially covers the outlet hole and an open position in which the outlet hole is exposed, wherein the writing material exits the cartridge through the exposed outlet hole into the advancing mechanism.

4. The writing instrument of claim 3, wherein the removable cartridge is configured to be axially slidably inserted into and removed from the body through an opening in the top end portion of the body, wherein the lid includes a bumper portion, wherein, when the cartridge is inserted into the body, the bumper portion contacts an interior surface of the body so as to cause the lid to move from the closed position to the open position.

5. The writing instrument of claim 4, wherein the lid further includes a lid hole, wherein, in the open position, the lid hole is substantially coaxially aligned with the outlet hole, whereby writing material exits the cartridge through the substantially aligned outlet hole and lid hole.

6. The writing instrument of claim 5, wherein the lid comprises a spring member that maintains the lid in the closed position substantially covering the outlet hole when the spring member is in a relaxed state.

7. The writing instrument of claim 1, wherein the removable cartridge is configured to be axially slidably inserted into and removed from an opening in the top end portion of the body.

8. The writing instrument of claim 7, further comprising a removable end cap that seals the opening in the top end portion of the body so as to secure the cartridge within the body.

9. The writing instrument of claim 1, wherein the advancing mechanism is contained in an advancing mechanism housing that forms a part of the bottom end portion of the body, and wherein the cartridge is contained in the top end portion of the body.

10. The writing instrument of claim 9, further comprising a head cap disposed proximate to the bottom end portion of the body, the head cap being disposed between the advancing mechanism housing and the tip, wherein the tip extends from the head cap and the head cap tapers in diameter toward the tip, and wherein the opening in the tip comprises a diameter substantially the same as an outer diameter of the writing material.

11. The writing instrument of claim 10, wherein the head cap and the body are discrete elements connected together.

12. The writing instrument of claim 10, wherein the bottom end portion and the top end portion of the body are integrally formed together in a monolithic structure.

13. The writing instrument of claim 1, wherein the top end portion of the body is translucent or transparent, wherein indicia are provided on an outside surface of the cartridge, the indicia being visible through the body.

14. The writing instrument of claim 13, wherein the first removable cartridge is configured to be axially slidably inserted into and removed from the body through an opening in the top end portion of the body,
wherein the first removable cartridge is interchangeable with a second removable cartridge containing a plurality of elongated writing materials and having an outside surface provided with second indicia different from the indicia provided on the surface of the first removable cartridge,
wherein the second removable cartridge is configured to be axially slidably inserted into the body through the opening after the first removable cartridge is removed from the body.

15. A writing instrument, comprising:
an exposed hollow elongated body;
a tip disposed proximate to a bottom end portion of the body and having an opening therein;
a removable cartridge disposed within the body and containing a plurality of elongated writing materials; and
a side knock advancing mechanism having a side-knock button operatively connected to an elongated plunger portion disposed within the body, wherein the plunger portion is axially bored with an advancing hole that communicates with the opening in the tip, wherein the advancing hole receives a writing material from the removable cartridge, wherein actuation of the side-knock button incrementally advances the writing material through the advancing hole of the elongated plunger portion into and outwardly beyond the opening in the tip.

16. The writing instrument of claim 15, wherein the removable cartridge comprises:
a first end and a second end spaced apart from the first end, the first end having a writing material outlet hole that communicates with; and
a lid disposed on the first end of the cartridge and moveable between a closed position in which the lid substantially covers the outlet hole and an open position in which the outlet hole is exposed, wherein the writing material exits the cartridge through the exposed outlet hole into the advancing hole of the advancing mechanism.

17. The writing instrument of claim 16, wherein the removable cartridge is configured to be axially slidably inserted into and removed from the body through an opening in a top end portion of the body opposite from the tip, wherein the lid includes a bumper portion, wherein, when the cartridge is inserted into the body, the bumper portion contacts an interior surface of the body so as to cause the lid to move from the closed position to the open position.

18. The writing instrument of claim 15, further comprising a removable end cap that seals the opening in the top end portion of the body so as to secure the cartridge within the body.

19. A writing instrument, comprising:
a hollow elongated writing instrument body;
a tip disposed proximate to a bottom end portion of the body;
a removable cartridge containing a plurality of elongated writing materials, the removable cartridge being disposed within the body and configured to be axially slidably inserted into and removed from the body through opening in a top end portion of the writing instrument body opposite from the tip, the cartridge comprising:
a cartridge body having a first end and a second end spaced apart from the first end, the first end having a writing material outlet hole; and
a lid having a lid hole and a bumper portion, the lid being disposed on a first end of the cartridge body and being configured to slide between a closed position and an open position,
wherein, in the closed position, the lid substantially covers the outlet hole, and the bumper portion of the lid extends radially beyond a periphery of the first end of the cartridge body, and
wherein, in the open position, the lid hole is substantially coaxially aligned with the outlet hole, wherein, when the cartridge is inserted into the writing instrument body, the bumper portion contacts an interior surface of the writing instrument body so as to cause the lid to slide from the closed position to the open position; and
a writing material advancing mechanism disposed in the body, for incrementally advancing the writing material from the outlet hole of the cartridge toward an opening in the tip.

20. The writing instrument of claim 19, wherein the lid comprises a spring member that maintains the lid in a closed position when the spring member is in a relaxed state.

21. The writing instrument of claim 19, wherein the writing instrument body comprises a transition at which the writing instrument body has a change in diameter, wherein the transition forms a projection on the interior surface of the writing instrument body, and wherein, when the cartridge is inserted into the writing instrument body, the bumper portion contacts the projection and the lid slides from the closed position to the open position.

22. The writing instrument of claim 19, further comprising an end cap comprising a top end and a bottom end, the bottom end covering the second end of the cartridge and comprising a bottom rim positioned with an interference fit on the exterior surface of the writing instrument body.
